(19) United States
(12) Patent Application Publication
(10) Pub. No.: US 2019/0369940 A1
(43) Pub. Date: Dec. 5, 2019

(54) CONTENT PROVIDING METHOD AND APPARATUS FOR VEHICLE PASSENGER

(71) Applicant: LG ELECTRONICS INC., Seoul (KR)

(72) Inventors: Kibong SONG, Seoul (KR); Hyunkyu KIM, Seoul (KR); Chulhee LEE, Seoul (KR); Sangkyeong JEONG, Seoul (KR); Junyoung JUNG, Seoul (KR)

(21) Appl. No.: 16/546,039

(22) Filed: Aug. 20, 2019

(30) Foreign Application Priority Data
Jun. 21, 2019 (KR) 10-2019-0074266

(51) Int. Cl. G06F 3/14; G09G 5/14; G06K 9/00

(52) U.S. Cl. CPC G06F 3/1423; H04L 67/10; G06K 9/00832; G09G 5/14

(57) ABSTRACT

There is provided a method of providing contents for a vehicle passenger, including: detecting, from a vehicle sensor, location information of the passenger, and location information and state information of a display where contents are being reproduced; acquiring, from the vehicle sensor, first data relating to contents being reproduced on the display, based on the detected location information and state information of the display; determining whether a degree of similarity between the first data and contents input into the display is equal to or more than a first threshold value; and changing an area in which the contents are reproduced based on the determined results.

### CROSS-REFERENCE TO RELATED APPLICATION

This application is based on and claims priority under 35 U.S.C. §119(a) to Korean Patent Application No. 10-2019-0074266, which was filed on Jun. 21, 2019, in the Korean Intellectual Property Office, the disclosure of which is incorporated herein in its entirety by reference.

### BACKGROUND

### 1. Field

This disclosure relates to a method and apparatus of providing contents for a vehicle passenger.

### 2. Description of the Related Art

A vehicle may include not only an automobile but also a train, a motorcycle, and the like, as means of transportation having only an internal combustion engine. Recently, as Al and autonomous driving technologies develop, research on a technology of providing contents through an in-vehicle display for the convenience of the vehicle passenger is being carried out.

Meanwhile, due to the mobility of the vehicle, in the technology of providing contents through an in-vehicle display unlike providing contents through a general display, it is necessary to take into consideration of vehicle driving, a change of an external environment, and an impact that may be made on the vehicle, and the like.

### SUMMARY

The disclosed embodiments are intended to disclose a method and apparatus of providing contents to the vehicle passenger based on a state of the display in the vehicle. A technical problem to be dealt with by the present embodiment is not limited to the aforementioned technical problems, and other technical problems may be inferred from the following embodiments.

According to an embodiment of the present invention, there is provided a method of providing contents for a vehicle passenger, including: detecting, from a vehicle sensor, location information of the passenger, and location information and state information of a display where contents are being reproduced; acquiring, from the vehicle sensor, first data relating to contents being reproduced on the display, based on the detected location information and state information of the display; determining whether a degree of similarity between the first data and contents input into the display is equal to or more than a first threshold value; and changing an area in which the contents are reproduced based on the determined results.

According to another embodiment, there is provided an apparatus of providing contents for a vehicle passenger, including: a processor configured to detect, from the vehicle sensor, location information of the passenger, and location information and state information of a display where contents are being reproduced, to acquire, from the vehicle sensor, first data relating to contents being reproduced on the display, based on the detected location information and state information of the display, to determine whether a degree of similarity between the first data and contents input into the display is equal to or more than a first threshold value, and to change an area in which the contents are reproduced, based on the determined results; a memory configured to store the location information of the passenger, the location information and state information of the display, the first data and the contents; and a communication unit connected to the processor, and configured to transmit or receive a signal between the processor and at least one of the vehicle sensor and the display.

The specific matters of other embodiments are included in the detailed description and drawings.

According to an embodiment of the present invention, there is one or more of the following effects.

Firstly, there is an effect that, in a case where a vehicle display is damaged, it is possible to continuously provide a vehicle passenger with contents by changing a display or one area on the display where contents are reproduced, according to a degree of damage.

Secondly, there is another effect that, when the display where contents are reproduced is changed due to damage of the vehicle display, it is possible to provide contents through another display that does not impose inconvenience to a touch input of the vehicle passenger by selecting the other display based on a location of the passenger.

Thirdly, there is still another effect that, in a case where the vehicle display erroneously recognizes a signal input from a passenger, it is possible to correct the signal input from the passenger based on data acquired through an in-vehicle sensor, thereby improving accuracy of an input signal of the passenger into the display.

The effects of the invention are not limited to the aforementioned effects, and other effects that have not been mentioned may be apparently understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an Al device 100 according to an embodiment of the present disclosure.

FIG. 2 illustrates Al server 200 according to an embodiment of the present disclosure.

FIG. 3 illustrates an Al system 1 according to an embodiment of the present disclosure.

FIG. 4 is a view illustrating an example of a method of providing contents for a vehicle passenger according to an embodiment of the present invention.

FIGS. 5A and 5B are views illustrating an example of a method of providing contents for a vehicle passenger, according to another embodiment of the present invention.

FIGS. 6A-6C are views illustrating an example of determining a degree of similarity between first data and contents, according to an embodiment of the present invention.

FIGS. 7A and 7B are views illustrating an example of changing an area in which contents are reproduced on a display, according to another embodiment of the present invention.

FIG. 8 is a view illustrating an example of changing a display where contents are reproduced, according to another embodiment of the present invention.

FIG. 9 is a view illustrating an example of determining a degree of similarity between second data and received input information, according to an embodiment of the present invention.

FIGS. 10A and 10B are views illustrating an example of providing contents, based on the degree of similarity between the second data and received input information according to an embodiment of the present invention.

FIG. 11 is a view illustrating an example of searching for an available display inside a vehicle and providing a vehicle passenger with contents, according to an embodiment of the present invention.

FIG. 12 is a block diagram of an apparatus of providing contents for a vehicle passenger, according to an embodiment of the present invention.

FIG. 13 is a diagram illustrating an interworking relationship between an external apparatus and an apparatus for providing contents for a vehicle passenger according to an embodiment of the present invention.

FIG. 14 is a flowchart illustrating a method of providing contents for a vehicle passenger, according to an embodiment of the present invention.

FIG. 15 is a flowchart illustrating a method of providing contents for a vehicle passenger, according to another embodiment of the present invention.

FIG. 16 is a flowchart illustrating a method of providing contents for a vehicle passenger, according to another embodiment of the present invention.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Exemplary embodiments of the present invention are described in detail with reference to the accompanying drawings. Detailed descriptions of technical specifications well-known in the art and unrelated directly to the present invention may be omitted to avoid obscuring the subject matter of the present invention. This aims to omit unnecessary description so as to make clear the subject matter of the present invention. For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification. It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams. Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions. According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

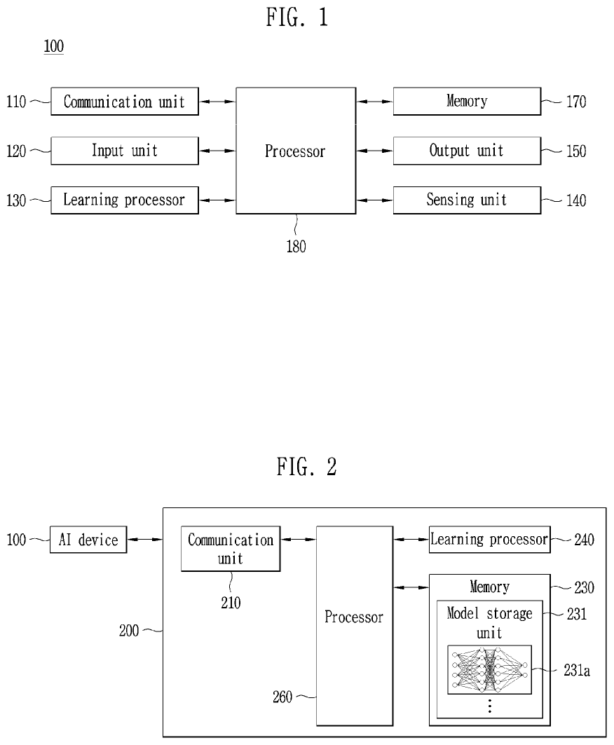

FIG. 1 illustrates an Al device 100 according to an embodiment of the present disclosure.

Al device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other Al devices 100a to 100e and an Al server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform Al processing along with a learning processor 240 of Al server 200.

At this time, learning processor 130 may include a memory integrated or embodied in Al device 100. Alternatively, learning processor 130 may be realized using memory 170, an external memory directly coupled to Al device 100, or a memory held in an external device.

Sensing unit 140 may acquire at least one of internal information of Al device 100 and surrounding environmental information and user information of Al device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of Al device 100. For example, memory 170 may store input data acquired by input unit 120, learning data, learning models, and learning history, for example.

Processor 180 may determine at least one executable operation of Al device 100 based on information determined or generated using a data analysis algorithm or a machine learning algorithm. Then, processor 180 may control constituent elements of Al device 100 to perform the determined operation.

To this end, processor 180 may request, search, receive, or utilize data of learning processor 130 or memory 170, and may control the constituent elements of Al device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of Al server 200, or may have learned by distributed processing of processors 130 and 240.

Processor 180 may collect history information including, for example, the content of an operation of Al device 100 or feedback of the user with respect to an operation, and may store the collected information in memory 170 or learning processor 130, or may transmit the collected information to an external device such as Al server 200. The collected history information may be used to update a learning model.

Processor 180 may control at least some of the constituent elements of Al device 100 in order to drive an application program stored in memory 170. Moreover, processor 180 may combine and operate two or more of the constituent elements of Al device 100 for the driving of the application program.

FIG. 2 illustrates Al server 200 according to an embodiment of the present disclosure.

Referring to FIG. 2, Al server 200 may refer to a device that causes an artificial neural network to learn using a machine learning algorithm or uses the learned artificial neural network. Here, Al server 200 may be constituted of multiple servers to perform distributed processing, and may be defined as a 5G network. At this time, Al server 200 may be included as a constituent element of Al device 100 so as to perform at least a part of Al processing together with Al device 100.

Al server 200 may include a communication unit 210, a memory 230, a learning processor 240, and a processor 260, for example.

Communication unit 210 may transmit and receive data to and from an external device such as Al device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in Al server 200 of the artificial neural network, or may be used in the state of being mounted in an external device such as Al device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

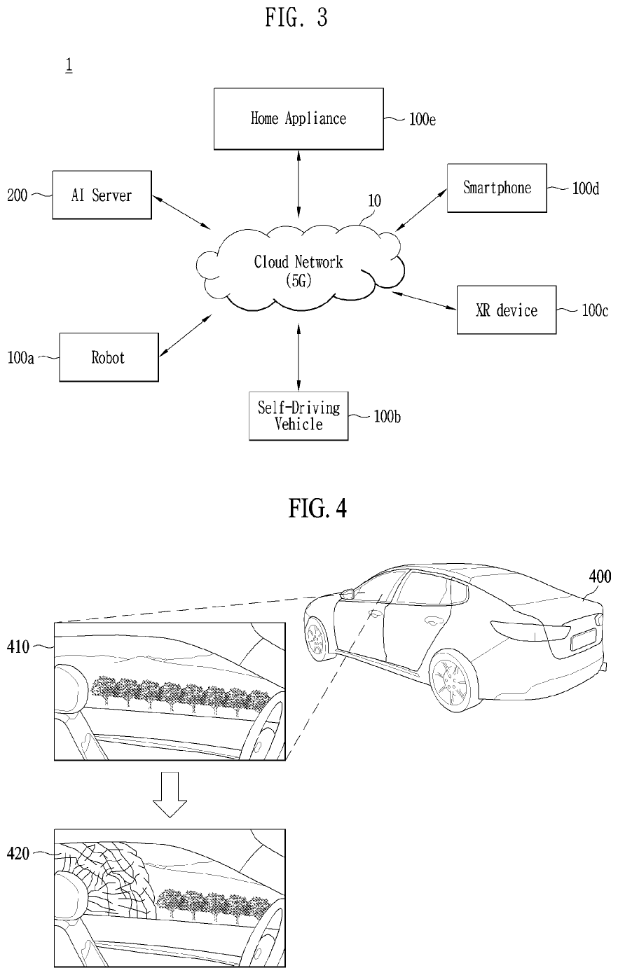

FIG. 3 illustrates an Al system 1 according to an embodiment of the present disclosure.

Referring to FIG. 3, in Al system 1, at least one of Al server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which Al technologies are applied, may be referred to as Al devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting Al system 1 may be connected to each other via cloud network 10. In particular, respective devices 100a to 100e and 200 may communicate with each other via a base station, or may perform direct communication without the base station.

Al server 200 may include a server which performs Al processing and a server which performs an operation with respect to big data.

Al server 200 may be connected to at least one of robot 100a, autonomous driving vehicle 100b, XR device 100c, smart phone 100d, and home appliance 100e, which are Al devices constituting Al system 1, via cloud network 10, and may assist at least a part of Al processing of connected Al devices 100a to 100e.

At this time, instead of Al devices 100a to 100e, Al server 200 may cause an artificial neural network to learn according to a machine learning algorithm, and may directly store a learning model or may transmit the learning model to Al devices 100a to 100e.

At this time, Al server 200 may receive input data from Al devices 100a to 100e, may deduce a result value for the received input data using the learning model, and may generate a response or a control instruction based on the deduced result value to transmit the response or the control instruction to Al devices 100a to 100e.

Alternatively, Al devices 100a to 100e may directly deduce a result value with respect to input data using the learning model, and may generate a response or a control instruction based on the deduced result value.

Hereinafter, various embodiments of Al devices 100a to 100e, to which the above-described technology is applied, will be described. Here, Al devices 100a to 100e illustrated in FIG. 3 may be specific embodiments of Al device 100 illustrated in FIG. 1.

Autonomous driving vehicle 100b may be realized into a mobile robot, a vehicle, or an unmanned air vehicle, for example, through the application of Al technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as Al server 200.

At this time, autonomous driving vehicle 100b may generate a result using the learning model to perform an operation, but may transmit sensor information to an external device such as Al server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

Meanwhile, it is obvious to those skilled in the art that the content providing apparatus according to an embodiment of the present invention may be an autonomous driving apparatus of controlling the autonomous driving vehicle or a component included in the autonomous driving apparatus. In addition, the content providing apparatus according to another embodiment of the present invention may be a separate component from the autonomous driving apparatus, and may be an apparatus provided for a general vehicle other than an autonomous driving vehicle.

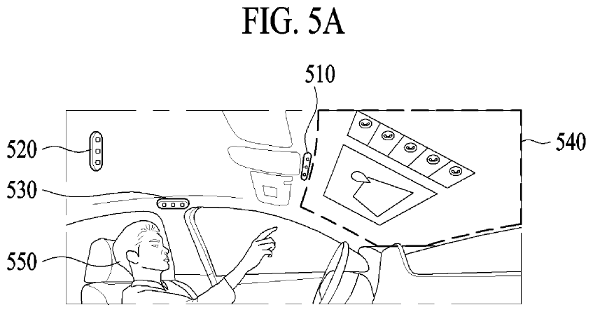

FIG. 4 is a view illustrating an example of a method of providing contents for a vehicle passenger according to an embodiment of the present invention.

With reference to FIG. 4, the content providing apparatus may display contents 410 through a display of a vehicle 400, in order to provide the contents 410 to the passenger of the vehicle 400. By the way, in a case where, due to an impact that has been made on the vehicle 400 or a display inside the vehicle 400, the display is broken, the content providing apparatus may not provide contents through a broken display 420. In this case, the content providing apparatus according to an embodiment of the present invention may determine a broken degree of the broken display 420 and may change a display or one area of the display where contents are reproduced, according to the broken degree.

Meanwhile, FIG. 4 illustrates a case where the display where contents are being reproduced is assumed to be broken. However, it is obvious to those skilled in the art that the content providing apparatus according to an embodiment of the present invention is utilized in all cases where the display fails to reproduce the contents, in addition to the case where the display is broken.

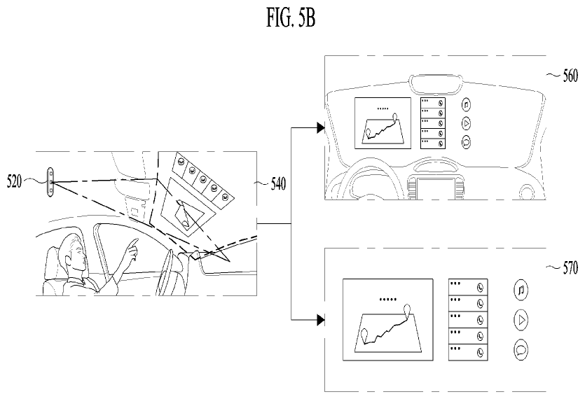

FIGS. 5A and 5B are views illustrating an example of a method of providing contents for a vehicle passenger, according to another embodiment of the present invention.

The content providing apparatus according to an embodiment of the present invention may detect location information of a vehicle passenger 550 and location information of a display 540 in which contents are being reproduced. With reference to FIG. 5A, a plurality of cameras 510, 520, and 530 may be disposed inside the vehicle. Here, since a first camera 510 captures an image including the passenger 550, and transfers the captured image to the content providing apparatus, the content providing apparatus may determine, through the captured image, whether or not the passenger 550 exists, and detect the location information of the passenger 550. In addition, at least one of a second camera 520 and a third camera 530 may capture an image of the display 540 in which contents are reproduced. The content providing apparatus may receive an image obtained by imaging the display 540 and may detect the location information and state information of the display 540 in which contents are reproduced.

Meanwhile, FIG. 5A illustrates an example of detecting the location information of the passenger, and the location information and state information of the display where contents are reproduced, by using a camera mounted on the vehicle. However, according to the embodiment of the present invention, the number of sensors and types of the sensors, which are used for detecting the location information of the passenger, and the location information and state information of the display where the contents are reproduced, are not limited thereto.

In addition, the content providing apparatus according to an embodiment of the present invention may check a presence of the passenger, based on the location information of the passenger detected through a sensor of the vehicle, and may acquire data of the area on the display where contents are reproduced. For example, the data may refer to an image of one area on the display where contents are reproduced, in the image obtained by imaging the display, but types of the data are not limited thereto.

With reference to FIG. 5B, the content providing apparatus may capture, through the second camera 520, an image 560 of the display 540 in which contents are reproduced. The image 560 may include an image of the contents currently being reproduced on the display.

Meanwhile, in order to provide contents to the passenger, the content providing apparatus inputs a signal relating to contents into the display, so that the content providing apparatus recognizes contents 570 being reproduced. Therefore, the content providing apparatus may check a reproduction state of the current contents, by comparing an image of the contents 570 input into the display, with an image of the contents being-reproduced that have been acquired through the second camera 520. In a case where the display 540 is broken, the contents checked by the image 560 acquired through the second camera 520 may be in a form in which a part of the contents is not displayed. In this way, the content providing apparatus may recognize that the contents 570 input into the display 540 for the purpose of reproduction are different from the contents currently being reproduced, and may change an area on the display where the contents are reproduced.

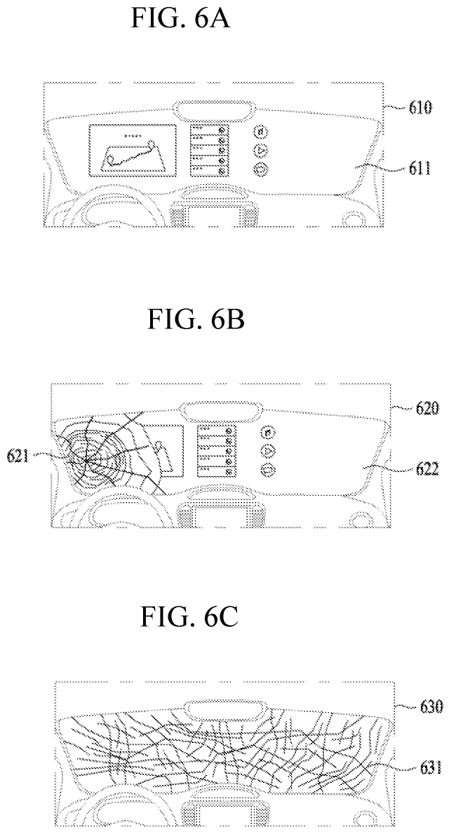

FIGS. 6A to 6C are views illustrating an example of determining a degree of similarity between first data and contents, according to an embodiment of the present invention.

The content providing apparatus according to an embodiment of the present invention may determine whether a degree of similarity between data acquired through the sensor of the vehicle and the contents input into the display is equal to or more than a threshold value and may change the area on the display where the contents are reproduced.

FIG. 6A illustrates an example of an image 610 acquired through a camera, in a case where the display is unbroken. With reference to FIG. 6A, since contents 611 input into the display for the purpose of reproduction and contents included in an image 610 captured by the camera are the same, there is no change in a display and an area on the display where the contents are reproduced.

Meanwhile, as illustrated in FIG. 6B, since a partial area 621 of the display is broken, contents 622 included in an image 620 captured by the camera and contents input into the display for the purpose of reproduction may be different. In this case, the content providing apparatus may determine whether a degree of similarity between contents being reproduced on the display and contents input into the display by the content providing apparatus is equal to or more than a threshold value.

Since, in a case where the threshold value is 50%, the partial area 621 of the broken display in FIG. 6B is less than 50% of the entire display area, it is possible to change the area in which contents are reproduced to an unbroken area on the display, so that the contents are provided.

However, as illustrated in FIG. 6C, in a case where most of the display is broken, there is a high probability that the degree of similarity between contents included in an image 630 captured by the camera and contents input into the display is less than the threshold value. In this case, the content providing apparatus may change a display to reproduce the contents.

In the case of FIGS. 6A to 6C, the threshold value of 50% is assumed as a threshold value relating to the degree of similarity between the contents included in the image captured by the camera and the contents input into the display. However, it is obvious to those skilled in the art that the threshold value is not limited thereto, but may vary depending on the performance and size of the display, types of contents, and the like.

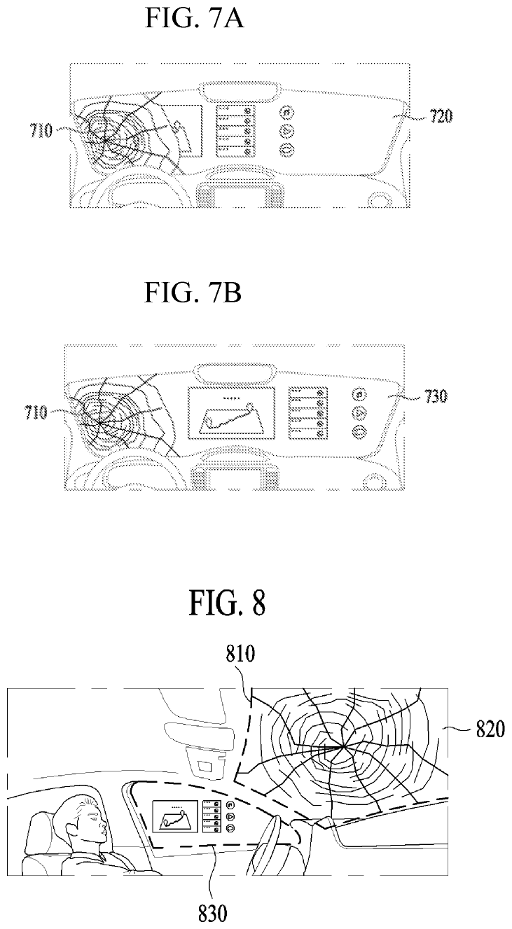

FIGS. 7A and 7B are views illustrating an example of changing an area in which contents are reproduced on a display, according to another embodiment of the present invention.

The content providing apparatus according to an embodiment of the present invention may change an area on a display where contents are reproduced, to allow contents to be reproduced in an unbroken area of the display.

For example, as illustrated in FIG. 7A, in a case where there is a broken area 710 on the display, contents 720 included in the image obtained by imaging the display are different from the contents input into the display. In this case, as illustrated in FIG. 7B, the content providing apparatus may provide contents 730 through the unbroken area of the display. In addition, the content providing apparatus may change a size of the contents 730 to provide contents through the unbroken area of the display.

FIG. 8 is a view illustrating an example of changing a display where contents are reproduced, according to another embodiment of the present invention.

In a case where a broken degree of the display where the contents are reproduced is high, the content providing apparatus according to an embodiment of the present invention may reproduce contents through another display, based on the degree of similarity between the first data and the contents input into the display.

With reference to FIG. 8, in a case where most of the area of the display where the contents are reproduced is broken, the contents may be difficult to be provided through a display 810. In this case, the content providing apparatus may select a display 830 to reproduce the contents, among displays different from the broken display 810, and may reproduce the contents through the selected display 830. Here, the content providing apparatus may detect location information of unbroken displays through a vehicle sensor, and may select the display 830 to reproduce the contents, based on the detected information.

At this time, since the content providing apparatus may select a display according to the location of a passenger, the passenger may maintain accessibility to the contents even though the display for providing the contents is changed.

In addition, the content providing apparatus according to an embodiment of the present invention may not only provide contents through the other display, but also may project the contents into the air near the broken display to provide the passenger with the contents. In this case, the content providing apparatus may receive an input of the passenger on the projected contents, by using the vehicle sensor.

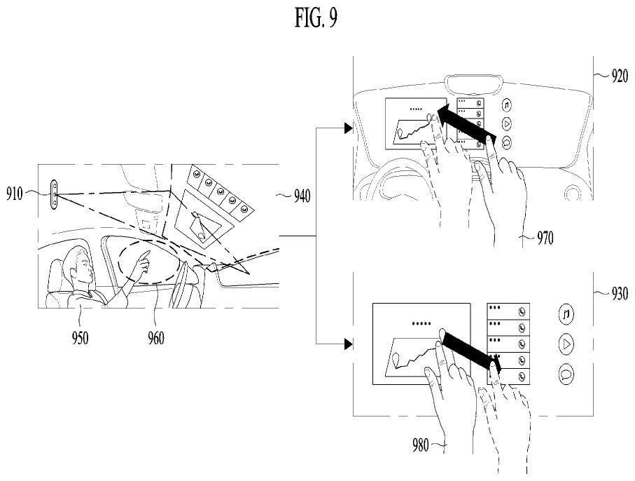

FIG. 9 is a view illustrating an example of determining a degree of similarity between second data and received input information, according to an embodiment of the present invention.

The content providing apparatus according to an exemplary embodiment of the present invention may acquire, from the vehicle sensor, second data relating to an input on a display by a passenger, and may receive information input onto the display to calculate a degree of similarity between the second data and received input information.

With reference to FIG. 9, a passenger 950 may take a gesture of dragging an item on the contents being reproduced on a front display 940 of the vehicle. At this time, the content providing apparatus may receive, from a display 940, information input by the passenger 950. In addition, it is possible to image an appearance of the passenger 950 taking a gesture through a camera 910 disposed inside the vehicle. Therefore, the content providing apparatus may calculate a degree of similarity between an image 920 relating to a gesture input of the passenger 950 captured by the camera 910 and input information 930 received from the display 940. At this time, even though, in the image 920 captured by the camera 910, input information 980 received from the display 940 refers to a gesture input of moving from left to right by the passenger 950 has been received, the gesture actually taken by the passenger 950 may be a gesture of moving from right to left. In this case, the content providing apparatus may correct input information of the passenger 950, based on the image 920 captured by the camera 910.

Meanwhile, in a case where the display 940 does not receive an input by the passenger 950, the content providing apparatus may acquire, from the vehicle sensor, data relating to the gesture input of the passenger 950, and receive an input signal based on the acquired data. For example, in a case where the display 940 does not receive a touch input by the passenger 950, data acquired through the vehicle sensor may indicate a gesture input of the passenger 950 pressing a button. Therefore, the content providing apparatus may receive the touch input by the passenger 950, based on the data acquired through the vehicle sensor.

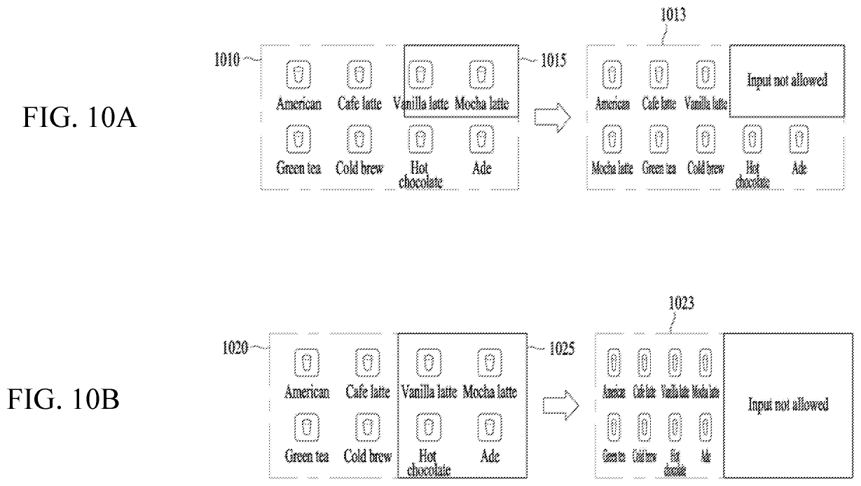

FIGS. 10A and 10B are views illustrating an example of providing contents, based on the degree of similarity between the second data and received input information according to an embodiment of the present invention.

When there is provided one area in which an input signal is unreceivable on the display, the content providing apparatus according to an embodiment of the present invention may display contents in a remaining area where the input signal is receivable, regardless of a degree of the damage of the display.

With reference to FIG. 10A, in a case where, out of an area 1010 in which contents are reproduced, there is provided one area 1015 in which the input signal of the passenger is unreceivable, the content providing apparatus may display a message indicating an “input not allowed” in that area 1015. In addition, the content providing apparatus may change contents, to allow the entire contents to be displayed in a remaining area 1013 excluding one area 1015, and may display the changed contents.

In addition, as illustrated in FIG. 10B, in a case where, out of an area 1020 in which the contents are reproduced, there is provided an area 1025 in which the input signal of the passenger is unreceivable, the content providing apparatus may display a message indicating an “input not allowed” in that area 1025. In addition, the content providing apparatus may reduce contents and display the reduced contents in a remaining area 1023 excluding that area 1025.

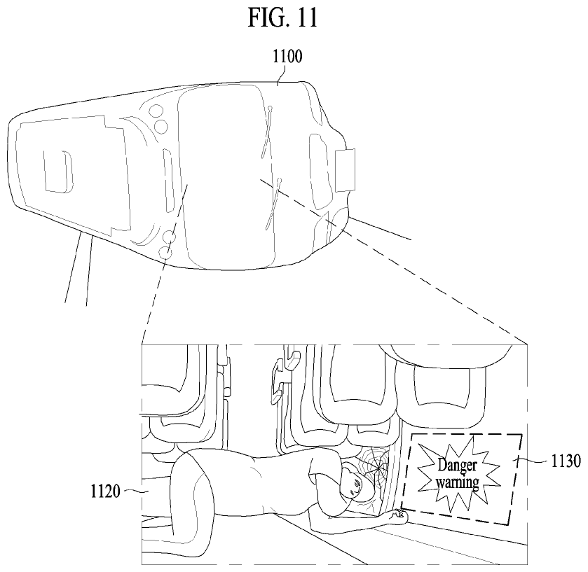

FIG. 11 is a view illustrating an example of searching for an available display inside a vehicle and providing a vehicle passenger with contents, according to an embodiment of the present invention.

In a case where the vehicle is broken, the content providing apparatus according to an embodiment of the present invention may search for an available display inside the vehicle and may provide contents to a vehicle passenger.

With reference to FIG. 11, in a case where an incident in which a vehicle 1100 is overturned occurs, a part of the internal display of the vehicle 1100 may be broken. At this time, the content providing apparatus may recognize a location of a passenger 1200 through the sensor of the vehicle, search for the available display among displays close to the passenger 1200, and display contents on a searched display 1130.

At this time, the display may be deformed due to the impact of a vehicle incident. In this case, a degree of deformation of the display may be recognized through the vehicle sensor, and an area in which the contents are to be displayed may be determined based on the degree of deformation.

In addition, in order to notify that a passenger 1200 of the vehicle 1100 is in a danger situation, the content providing apparatus may display a danger warning on the display 1130 or provide the passenger 1200 with contents for incident response, through the display 1130. However, the contents displayed on the available display 1130 are not limited thereto.

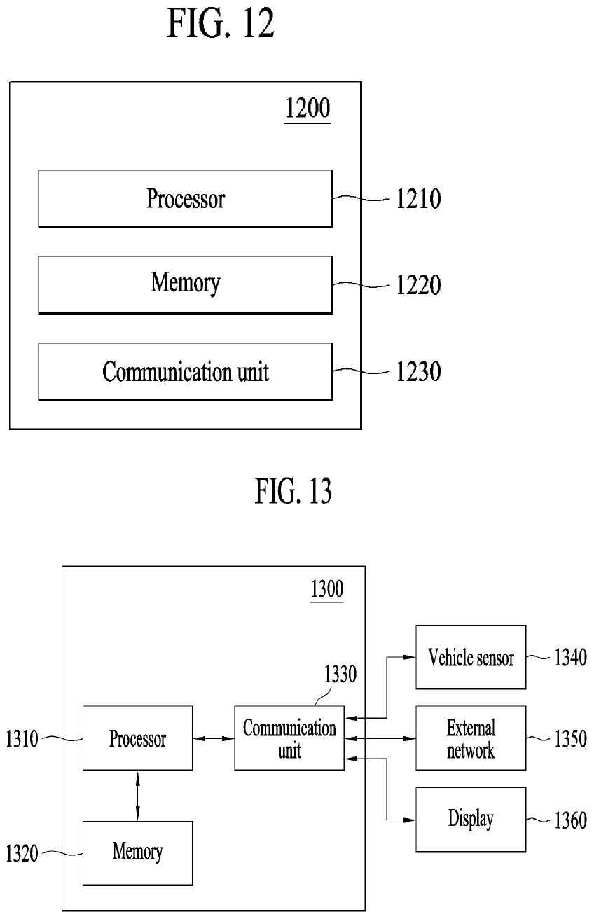

FIG. 12 is a block diagram of an apparatus of providing contents for a vehicle passenger, according to an embodiment of the present invention.

The content providing apparatus 1200 according to an embodiment of the present invention may include a processor 1210, a memory 1220, and a communication unit 1230.

The processor 1210 usually controls the overall operation of the content providing apparatus 1200. For example, in general, the processor 1210 may control the communication unit 1230, other components of the vehicle, and the like, by executing a program stored in the memory 1220. In addition, the processor 1210 may perform a function of the content providing apparatus, indicated in FIGS. 5A to 11, by executing the program stored in the memory 1220.

In addition, the processor 1210 may detect, from a vehicle sensor, a location information of the passenger, and location information and state information of a display where contents are being reproduced; acquire, from the vehicle sensor, first data relating to the contents being reproduced on the display, based on the detected location information and state information of the display; determine whether a degree of similarity between the first data and the contents input into the display is equal to or more than a first threshold value; and change an area in which the contents are reproduced, based on the determined results. Here, a changed area of reproducing contents may include at least one of one area on the display and one area on another display, and the state information of the display may include at least one of information on the degree of the damage of the display and information on the degree of the impact of the vehicle. In a case where the vehicle sensor according to an embodiment of the present invention includes a camera, the first data may be image data.

Meanwhile, as a result, in a case where it is determined that a degree of similarity between the first data and the contents input into the display is less than the first threshold value and is equal to or more than a third threshold value, the processor 1210 may change an area in which the contents are reproduced on the display, based on a resolution at which a normal output of the display is possible.

In addition, as a result, in a case where it is determined that a degree of similarity between the first data and the contents input into the display is less than the first threshold value and is equal to or more than the third threshold value, the processor 1210 may change an area in which the contents is reproduced, into an area in which the normal output is possible among areas on the display.

As a result, in a case where it is determined that the degree of similarity between the first data and the contents input into the display is less than the third threshold value, the third threshold value being less than the first threshold value, the processor 1210 may change an area in which the contents are reproduced, into one area on another display. Here, the display changed to the area in which the contents are reproduced may be a display located within a distance where the touch input is receivable by the passenger.

In addition, the processor 1210 may acquire, from the vehicle sensor, second data relating to an input on the display by the passenger, receive information input onto the display, from the display through the communication unit 1230, calculate a degree of similarity between the second data and received input information, and correct input information on the display by the passenger, based on the calculated results. Here, the input information on the display may include at least one of location information of a touch input on the display and information on a gesture input, a click input, a double-click input, and a drag input.

Specifically, the processor 1210 may correct input information on the display based on the second data, in a case where a degree of similarity between the second data and received input information is less than or equal to the second threshold value.

Meanwhile, the memory 1220 may store the location information of the passenger, the location information and the state information of the display, the first data and the contents.

In addition, the communication unit 1230 may be coupled to the processor 1210 to transmit or receive signals between the processor 1210 and at least one of the vehicle sensor and the display.

Meanwhile, the other features and functions of the memory 1220 and the communication unit 1230 correspond to those of the memory 170 and the communication unit 110 in FIG. 1. Therefore, detailed description thereof will not be repeated.

FIG. 13 is a diagram illustrating an interworking relationship between an external apparatus and an apparatus for providing contents for a vehicle passenger according to an embodiment of the present invention.

A processor 1310 of the content providing apparatus 1300 may control a memory 1320 and a communication unit 1330. Meanwhile, the processor 1310 may receive, from the memory 1320, the location information of the passenger, the location information and state information of the display, the first data and the contents, and information received from a vehicle sensor 1340, an external network 1350, and a display 1360 may be transferred through the communication unit 1330 to the processor 1310.

In other words, the communication unit 1330 of the content providing apparatus 1300 may be connected to the vehicle sensor 1340, the external network 1350, and the display 1360 by wired or wireless connection, and transmit or receive signals.

For example, the communication unit 1300 may receive sensor information from the vehicle sensor 1340 and transmit a control signal relating to the vehicle sensor 1340. However, transmission or reception information between the communication unit 1330 and the vehicle sensor 1340 is not limited thereto.

Meanwhile, the communication unit 1330 may make a request for contents to be provided to the passenger through the external network 1350, and receive the contents from the external network 1350. However, the information transmitted or received between the communication unit 1330 and the external network 1350 is not limited thereto.

Meanwhile, the display 1360 in FIG. 13 may include displays attached to a windshield and a window of the vehicle, and a component inside the vehicle. In addition, the display 1360 may include a transparent display having predetermined transparency and displaying the contents input from the content providing apparatus.

In order to have transparency, the transparent display may include at least one of a transparent Thin Film Electroluminescent (TFEL), a transparent Organic Light-Emitting Diode (OLED), a transparent Liquid Crystal Display (LCD), a transmissive transparent display, and a transparent Light Emitting Diode (LED), and the transparency of the transparent display may be adjusted. According to the embodiment, the contents reproduced on the display located on the window of the vehicle may be provided with high transparency, in a case where the vehicle does not drive autonomously. Accordingly, the user may understand the surrounding environment together with the contents. According to another embodiment, the contents may not be reproduced on the display in the window of the vehicle in which the external information may be acquired in the case where the vehicle does not drive autonomously.

The communication unit 1300 may input contents to the display 1360 and receive an input signal input by the passenger from the display 1360. However, the information transmitted or received between the communication unit 1300 and the display 1360 is not limited thereto.

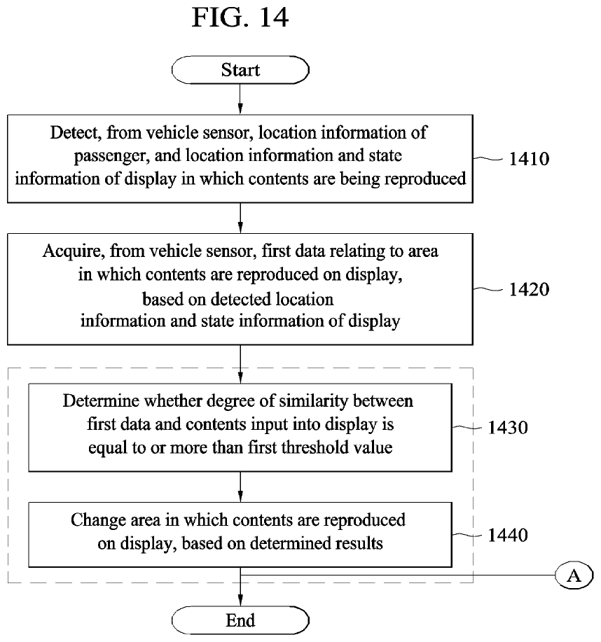

FIG. 14 is a flowchart illustrating a method of providing contents for a vehicle passenger, according to an embodiment of the present invention.

In step 1410, the content providing apparatus may detect, from the vehicle sensor, the location information of the passenger, and the location information and the state information of the display where contents are being reproduced. At this time, the content providing apparatus may detect the location information of the passenger, and the location information and the state information of the display where contents are being reproduced, based on sensor information received from a plurality of vehicle sensors, and may detect the information through a single vehicle sensor. However, the number of specific vehicle sensors is not limited thereto. In addition, the vehicle sensor is a camera, and based on an image captured by the camera, the location information of the passenger, the location information and state information of the display where contents are being reproduced, and the state information may be detected. However, a type of the vehicle sensor is not limited thereto.

In step 1420, the content providing apparatus may acquire, from the vehicle sensor, first data relating to the contents being reproduced on the display, based on the detected location information and state information of the display. For example, in a case where the vehicle sensor is a camera and the camera captures an image including the display, the first data may be data relating to the contents being reproduced included in the captured image.

In step 1430, the content providing apparatus may determine whether a degree of similarity between the first data and the contents input into the display is equal to or more than a first threshold value. The content providing apparatus may input the contents onto the display, to allow the contents to be displayed on the display. Therefore, the content providing apparatus may calculate the degree of similarity between the contents input into the display and the first data, and may determine whether the degree of similarity is equal to or more than the first threshold value. Here, it is obvious to those skilled in the art that the first threshold value is not limited to a certain value and may vary depending on the performance and size of the display, types of contents, and the like.

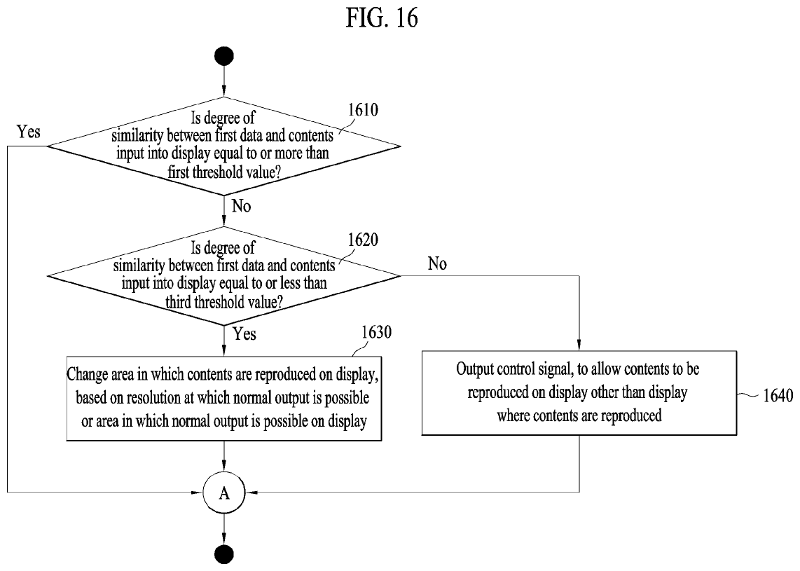

In step 1440, the content providing apparatus may change an area in which the contents are reproduced, based on the determined results. Here, the changed area of reproducing contents may include at least one of the one area on the display and one area on the other display. A specific method of determining the changed area of reproducing contents will be described in detail with reference to FIG. 16.

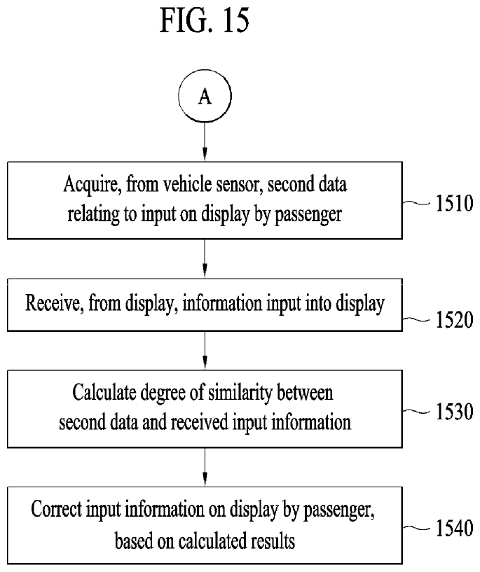

FIG. 15 is a flowchart illustrating a method of providing contents for a vehicle passenger, according to another embodiment of the present invention.

In step 1510, the content providing apparatus may acquire, from the vehicle sensor, second data relating to an input on the display by the passenger. For example, in a case where the vehicle sensor is a camera and the camera captures an image including the gesture of the passenger, the second data may be data on a gesture of the passenger included in the captured image.

In step 1520, the content providing apparatus may receive, from the display, information input into the display.

In step 1530, the content providing apparatus may calculate a degree of similarity between the second data and received input information.

In step 1540, the content providing apparatus may correct input information on the display by the passenger, based on the calculated results. In a case where it is determined that an input of the passenger into the display is a click input, based on the second data, but input information received from the display refers to a double-click input, the content providing apparatus displays may correct the input to be a click input by the passenger, based on the second data. Therefore, in a case where a problem occurs in receiving an input of the passenger even if the display reproduces the contents without problems, the content providing apparatus may correct the input of the passenger based on data acquired through the vehicle sensor, thereby improving accuracy of the input signal of the passenger into the display. In addition, in a case where the display includes an area where the passenger may not receive the input signal even though the display is not damaged, the content providing apparatus according to an embodiment of the present invention may display contents in a remaining area excluding that area.

FIG. 16 is a flowchart illustrating a method of providing contents for a vehicle passenger according to another embodiment of the present invention.

The content providing apparatus according to an embodiment of the present invention has an effect of variously changing an area in which the contents are reproduced, by comparing a degree of similarity between the first data and the contents input into the display with a plurality of threshold values.

Meanwhile, steps in FIG. 16 may be performed instead of steps 1430 and 1440 in FIG. 14.

In step 1610, the content providing apparatus may determine whether a degree of similarity between the first data and the contents input into the display is equal to or more than a first threshold value. In a case where the degree of similarity is equal to or more than the first threshold value, the contents reproduced through the display may indicate no problem. Therefore, in a case where the degree of similarity is equal to or more than a first threshold value, step A in FIG. 15 may proceed, and otherwise, step 1620 may be performed.

In step 1620, the content providing apparatus may determine whether the degree of similarity between the first data and the contents input into the display is equal to or more than a third threshold value. Here, the third threshold value may be a value less than the first threshold value. In a case where the degree of similarity is equal to or more than the third threshold value, step 1630 may be performed, and otherwise, step 1640 may be performed.

For example, in a case where the first threshold value is 80% and the third threshold value is 20%, the content providing apparatus proceeds to step 1620 when the degree of similarity between the first data and the contents input into the display is less than 80%. In a case where the degree of similarity between the first data and the contents input into the display is equal to or more than 20%, the content providing apparatus may display the contents in another area of that display, so that step 1630 may be performed. Otherwise, the step 1640 may be performed to reproduce the contents through a display other than that display.

In step 1630, the content providing apparatus may change an area in which the contents are reproduced on the display, based on the resolution at which the normal output is possible or area in which the normal output is possible on the display.

In step 1640, the content providing apparatus may output a control signal, to allow contents to be reproduced on a display other than a display where the contents are reproduced.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of providing contents for a vehicle passenger, comprising:
detecting, from a vehicle sensor, location information of the passenger, and location information and state information of a display where contents are being reproduced;
acquiring, from the vehicle sensor, first data relating to contents being reproduced on the display, based on the detected location information and state information of the display;
determining whether a degree of similarity between the first data and contents input into the display is equal to or more than a first threshold value; and
changing an area in which the contents are reproduced based on the determined results, wherein the changed area of reproducing contents includes at least one of one area on the display and one area on another display.

2. The method of claim 1, further comprising:
acquiring, from the vehicle sensor, second data relating to an input on the display by the passenger;
receiving, from the display, information input into the display;
calculating a degree of similarity between the second data and received input information; and
correcting the input information on the display by the passenger, based on the calculated results.

3. The method of claim 2, wherein, in a case where the degree of similarity between the second data and the received input information is less than or equal to a second threshold value,
the correcting the input information on the display is based on the second data.

4. The method of claim 2, wherein the input information on the display includes at least one of location information of a touch input on the display and information on a gesture input, a click input, a double-click input, and a drag input.

5. The method of claim 1, wherein the state information of the display includes at least one of information on a degree of the damage of the display, and information on a degree of the impact of the vehicle.

6. The method of claim 1, wherein, as a result, in a case where it is determined that a degree of similarity between the first data and contents input into the display is less than the first threshold value and is equal to or more than a third threshold value,
the changing an area in which the contents are reproduced indicates changing an area in which the contents are reproduced on the display, based on a resolution at which a normal output of the display is possible.

7. The method of claim 1, wherein, as a result, in a case where it is determined that a degree of similarity between the first data and contents input into the display is less than the first threshold value and is equal to or more than a third threshold value,
the changing an area in which the contents are reproduced indicates changing an area where the contents are reproduced, into an area in which a normal output is possible among areas on the display.

8. The method of claim 1, wherein, as a result, in a case where it is determined that a degree of similarity between the first data and contents input into the display is less than or equal to a third threshold value, the third threshold value being less than the first threshold value,
the changing an area in which the contents are reproduced indicates changing an area in which the contents are reproduced, into one area on the other display.

9. The method of claim 8, wherein the other display is a display located within a distance where a touch input is receivable by the passenger.

10. The method of claim 1, wherein the vehicle sensor includes a camera and the first data is image data.

11. An apparatus of providing contents for a vehicle passenger, comprising:
a processor configured to detect, from the vehicle sensor, location information of the passenger, and location information and state information of a display where contents are being reproduced, to acquire, from the vehicle sensor, first data relating to contents being reproduced on the display, based on the detected location information and state information of the display, to determine whether a degree of similarity between the first data and contents input into the display is equal to or more than a first threshold value, and to change an area in which the contents are reproduced, based on the determined results, wherein the changed area of reproducing contents includes at least one of one area on the display and one area on another display;
a memory configured to store the location information of the passenger, the location information and state information of the display, the first data and the contents; and
a communication unit connected to the processor, and configured to transmit or receive a signal between the processor and at least one of the vehicle sensor and the display.

12. The apparatus of claim 11, wherein the processor is configured to acquire, from the vehicle sensor, second data relating to an input on the display by the passenger, to receive, from the display through the communication unit, information input into the display, to calculate a degree of similarity between the second data and received input information, and to correct input information on the display by the passenger, based on the calculated results.

13. The apparatus of claim 12, wherein, in a case where the degree of similarity between the second data and the received input information is less than or equal to a second threshold value, the processor is configured to correct input information on the display, based on the second data.

14. The apparatus of claim 12, wherein the input information on the display includes at least one of location information of a touch input on the display and information on a gesture input, a click input, a double-click input, and a drag input.

15. The apparatus of claim 11, wherein the state information of the display includes at least one of information on a degree of the damage of the display, and information on a degree of the impact of the vehicle.

16. The apparatus of claim 11, wherein, as a result, in a case where it is determined that a degree of similarity between the first data and contents input into the display is less than the first threshold value and is equal to or more than a third threshold value,
the changing an area in which contents are reproduced indicates changing an area in which the contents are reproduced on the display, based on a resolution at which a normal output of the display is possible.

17. The apparatus of claim 11, wherein, as a result, in a case where it is determined that a degree of similarity between the first data and contents input into the display is less than the first threshold value and is equal to or more than a third threshold value,
the changing an area in which contents are reproduced indicates changing an area in which the contents are reproduced, into an area in the display where a normal output is possible among areas on the display.

18. The apparatus of claim 11, wherein, as a result, in a case where it is determined that a degree of similarity between the first data and contents input into the display is less than a third threshold value, the third threshold value being less than the first threshold value,
the changing an area in which the contents are reproduced indicates changing an area in which the contents are reproduced, into one area on the other display.

19. The apparatus of claim 18, wherein the other display is a display located within a distance where a touch input is receivable by the passenger.

20. A computer-readable recording medium that records an instruction for executing a method of claim 1 on a computer.
